(19) United States
(12) Patent Application Publication
(10) Pub. No.: US 2017/0293895 A1
(43) Pub. Date: Oct. 12, 2017

(54) DEVICE AND METHOD FOR CALCULATING DAMAGE REPAIR COST

(71) Applicants: Fu Tai Hua Industry (Shenzhen) Co., Ltd., Shenzhen (CN); HON HAI PRECISION INDUSTRY CO., LTD., New Taipei (TW)

(72) Inventor: SHENG-YANG SONG, Shenzhen (CN)

(21) Appl. No.: 15/480,393

(22) Filed: Apr. 6, 2017

(30) Foreign Application Priority Data
Apr. 11, 2016 (CN) 201610219985.6

(51) Int. Cl. G06Q 10/00; G01L 1/00; G07C 5/08; G06Q 30/02; G07C 5/00

(52) U.S. Cl. CPC G06Q 10/20; G06Q 30/0283; G07C 5/006; G07C 5/0816; G07C 5/085; G01L 1/005

(57) ABSTRACT

A cost calculating device mounted on a vehicle to calculate repair cost for damage includes a number of pressure sensors, at least one flaw detector, and a processor. The pressure sensors detect changes in pressure value in collisions. The processor acquires the pressure values from each of the pressure sensors and determines whether a pressure value is greater than a preset value. The flaw detector detects damage data if the acquired pressure value is greater than the preset value. The processor further determines a damage ratio according to the damage data and a pre-stored data for undamaged vehicle, and determines a repair cost according to the damage ratio and a pre-stored table recording a relationship between different damage ratios and repair costs. A cost calculating method is also provided.

### CROSS-REFERENCE TO RELATED APPLICATIONS

This application claims priority to Chinese Patent Application No. 201610219985.6 filed on Apr. 11, 2016.

### FIELD

The subject matter herein generally relates to calculating repair cost for damage, and particularly to a device and method for calculating repair cost when a damage occurs.

### BACKGROUND

The number of vehicles, such as motorcycles and private cars, is growing fast. Traffic accidents are more frequent. When a traffic accident occurs, for example involving a private car, a repair cost is needed to be calculated.

### BRIEF DESCRIPTION OF THE DRAWINGS

Implementations of the present technology will now be described, by way of example only, with reference to the attached figures.

FIG. 1 is a block diagram illustrating an embodiment of a repair cost calculating device.

FIG. 2 is a schematic diagram illustrating an operating environment of the repair cost calculating device of FIG. 1.

FIG. 3 is a schematic diagram illustrating an embodiment of a table stored in a storage device of the repair cost calculating device of FIG. 1.

FIG. 4 is a schematic diagram illustrating an embodiment of a user interface displayed in the repair cost calculating device of FIG. 1.

FIG. 5 is a flowchart illustrating an embodiment of a method for calculating repair cost for damage.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”, it specifically indicates open-ended inclusion or membership in a so-described combination, group, series, and the like.

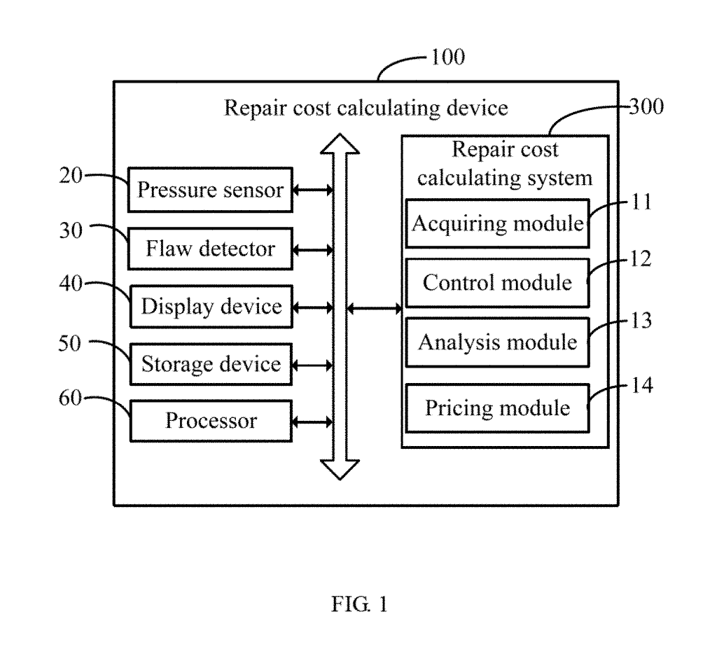

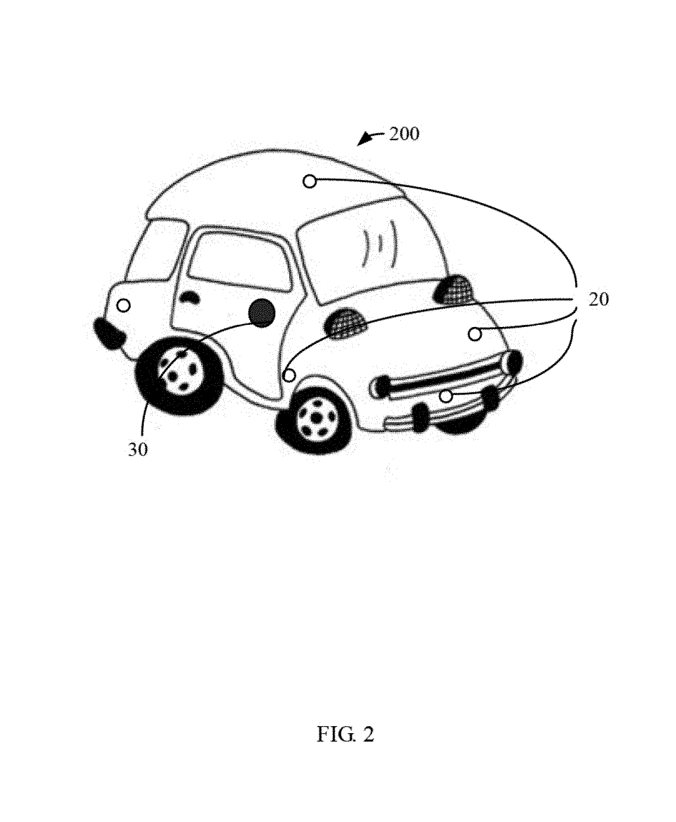

FIG. 1 illustrates an exemplary embodiment of a repair cost calculating device 100 (hereinafter “calculating device 100”) for calculating repair cost. In the exemplary embodiment, the calculating device 100 is mounted on a vehicle 200 (see FIG. 2) to detect damage data when a collision (for example a traffic accident) is occurred to the vehicle 200. The calculating device 100 further can calculate a repair cost of the vehicle 200 when the vehicle 200 is damaged in the collision. In other embodiments, the calculating device 100 can be an internal component of the vehicle 200. In the exemplary embodiment, the vehicle 200 can be, but is not limited to, a bicycle, a motorcycle, a private car, a bus, a truck, and the like. It can be understood that the calculating device 100 further can be applied to other devices which need to calculate repair costs when the device is damaged.

In the exemplary embodiment, the calculating device 100 can include, but is not limited to, a number of pressure sensors 20, at least one flaw detector 30, a display device 40, a storage device 50, and a processor 60. The processor 60 communicates with the pressure sensors 20, the flaw detector 30, the display device 40, and the storage device 50. In the exemplary embodiment, the vehicle 200 is a car taken as an example.

Referring to FIG. 2, the pressure sensors 20 are mounted on different locations of the vehicle 200 to detect a pressure value when a collision is occurred to the vehicle 200. In the exemplary embodiment, the pressure sensors 20 are mounted on parts vulnerable to damage, for example, the front of the car, the rear of the car, the door of the car, the driving mirror, the car lamps, and the like.

The flaw detector 30 is configured to detect damage data of the vehicle 200. In the exemplary embodiment, the damage data can include, but is not limited to, a location of the damage, a type of the damage, a size of a damage area, and a depth of the damage area. For example, the location of the damage can be a door of the car, the type of the damage can include, but is not limited to, cracks caused, bodywork dents, lost parts, broken parts, and the like. In the exemplary, the flaw detector 30 can be, but is not limited to, a digital ultrasonic flaw detector, the flaw detector 30 detects the damage data of the vehicle 200 by emitting ultrasonic waves to the vehicle 200 and receiving ultrasonic waves reflected by the vehicle 200. The flaw detector 30 further can be other existing detectors, for example eddy current flaw detector or magnetic defect detectors. In the exemplary embodiment, the flaw detector 30 is mounted on a chassis of the vehicle 200.

The display device 40 can be, but is not limited to, a screen of a navigating system of the vehicle 200. The storage device 50 can be, but is not limited to, an internal storage system, such as a flash memory, a random access memory (RAM) for temporary storage of information, and/or a read-only memory (ROM) for permanent storage of information. The storage device 50 can also be a storage system, such as a hard disk, a storage card, or a data storage medium. The processor 60 can be, but is not limited to, a central processing unit, a digital signal processor, or a single chip, for example.

Referring to FIG. 1, the storage device 50 can store a repair cost calculating system 300 (hereinafter “calculating system 300”) for damage. The calculating system 300 can include a number of modules, which are collection of software instructions stored in the storage device 50 and executed by the processor 60. In at least one embodiment, the calculating system 300 can include an acquiring module 11, a control module 12, an analysis module 13, and a pricing module 14.

The acquiring module 11 acquires a pressure value from each pressure sensor 20. In one embodiment, each pressure sensor 20 continuously detects pressure being experienced, determines a pressure value and sends the pressure value to the processor 60 at regular time intervals. In an alternative embodiment, each pressure sensor 20 continuously detects the pressure value and determines whether the detected pressure value is dramatically changed. In the exemplary embodiment, each pressure sensor 20 includes a unique identification, the acquiring module 11 further acquires the unique identification of the pressure sensor 20 along with the pressure value.

The control module 12 determines whether the acquired pressure value is greater than a preset value. In the exemplary embodiment, the preset value is a pressure value which represents a minimal level of damage to the vehicle 200. If the control module 12 determines that the acquired pressure value is greater than the preset value, the control module 12 determines that the vehicle 200 is damaged, then the control module 12 controls the flaw detector 30 to detect the damage data of the vehicle 200. In the exemplary embodiment, the control module 12 obtains the unique identification of the pressure sensor 20 from which the pressure value is acquired, and controls the flaw detector 30 to detect the damage data around a location of the pressure sensor 20 which is sending the pressure value. In an alternative embodiment, the control module 12 controls the flaw detector 30 to detect the damage data of each part of the vehicle 200 sequentially.

The analysis module 13 obtains the damage data from the flaw detector 30 and determines a damage ratio according to the damage data obtained from the flaw detector 30 and a pre-stored data which represents an undamaged vehicle 200. In the exemplary embodiment, the pre-stored data is stored in the storage device 50, and when the flaw detector 30 transmits the damage data to the processor 60, the analysis module 13 determines the damage ratio according to the obtained damage data and the pre-stored data. In other embodiments, the pre-stored data is stored in the flaw detector 30, the flaw detector 30 detects the damage data and compares the damage data with the pre-stored data. If the damage data is different from the pre-stored data, the flaw detector 30 transmits the detected damage data and the pre-stored data to the processor 60. If the damage data is the same as the pre-stored data, the flaw detector 30 does not transmit the detected damage data and the pre-stored data to the processor 60.

In the exemplary embodiment, the determination as to damage ratio by the analysis module 13 can include: comparing the damage data with the pre-stored data; determining a name of the damaged component according to the location of the damage if the damage data is different from the pre-stored data; and determining a damage ratio according to a difference between the damage data and the pre-stored data. In the exemplary embodiment, the damage ratio may be equal to zero or greater than zero, and will be less than or equal to one.

In the exemplary embodiment, the analysis module 13 further obtains an image of a damaged component and controls the display device 40 to display the image of the damaged component. In the exemplary embodiment, the analysis module 13 generates the image of the damaged component according to the damage data detected by the flaw detector 30. In other embodiment, a camera is employed by the analysis module 13 to obtain the image of the damaged component.

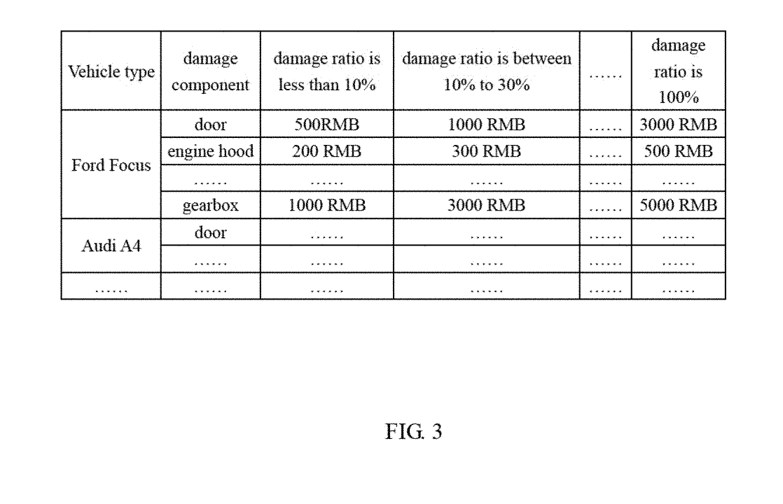

Referring to FIG. 3, in the exemplary embodiment, the storage device 50 stores a table 400 recording a name of each component of the vehicle 200, and a relationship between damage ratios and damage repair costs of each component of the vehicle 200. The table 400 further can store a mapping relationship between a number of vehicle types and the damage repair costs. For example, the table 400 may records Ford Focus as a vehicle type, the names of the components of Ford Focus can include the doors, the engine hood, the gearbox, and so on. For a door, if the damage ratio is less than 10%, the damage ratio corresponds to a damage repair cost of 500 RMB, if the damage ratio is between 10% to 30%, the damage repair cost is 1000 RMB, and if the damage ratio is 100%, the damage repair cost is 3000 RMB.

The pricing module 14 determines a damage repair cost according to the damage ratio determined by the analysis module 13 and the table 400, and displays the damage repair cost on the display device 40. In other embodiments, the storage device 50 stores a table recording an original price of each component of the vehicle, the pricing module 14 obtains the original price of the damage component of the vehicle, and calculates the damage repair cost by multiplying the original price of the damage component by the damage ratio to get the damage repair cost.

In the exemplary embodiment, if more than one component is damaged, the pricing module 14 further sums the damage repair cost of each damaged component to get a total damage repair cost, and outputs the total damage repair cost by using the display device 40.

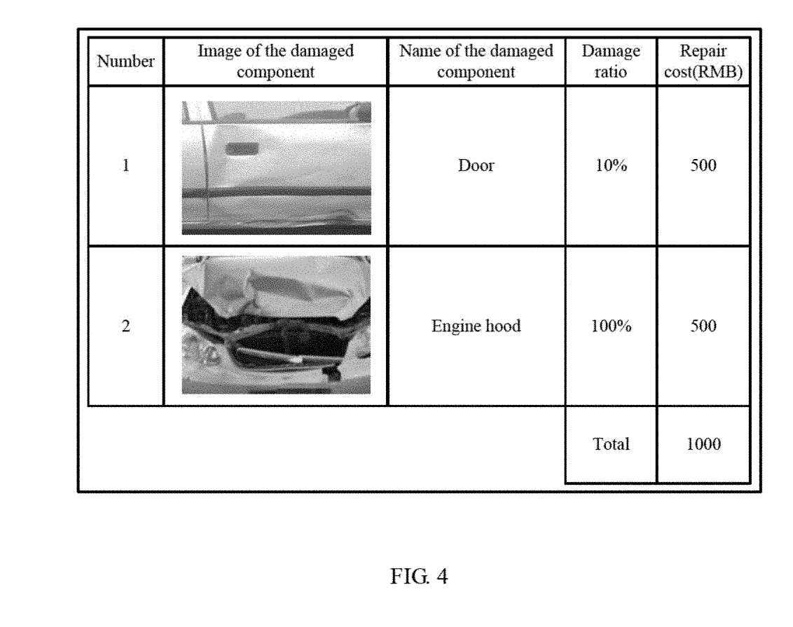

Referring to FIG. 4, in the exemplary embodiment, the control module 12 further controls the display device 40 to display a user interface to output the damage repair cost to the user. In the exemplary embodiment, the user interface shows the image of each damaged component, the name of each damaged component, the damage ratio of each damaged component, and the damage repair cost of each damaged component, and a total damage repair cost.

The repair cost calculating device 100 can automatically determine the repair cost of the damage when a traffic accident happens to the vehicle 200. It is convenient for the owner of the vehicle 200 to obtain indemnities or calculate payment due.

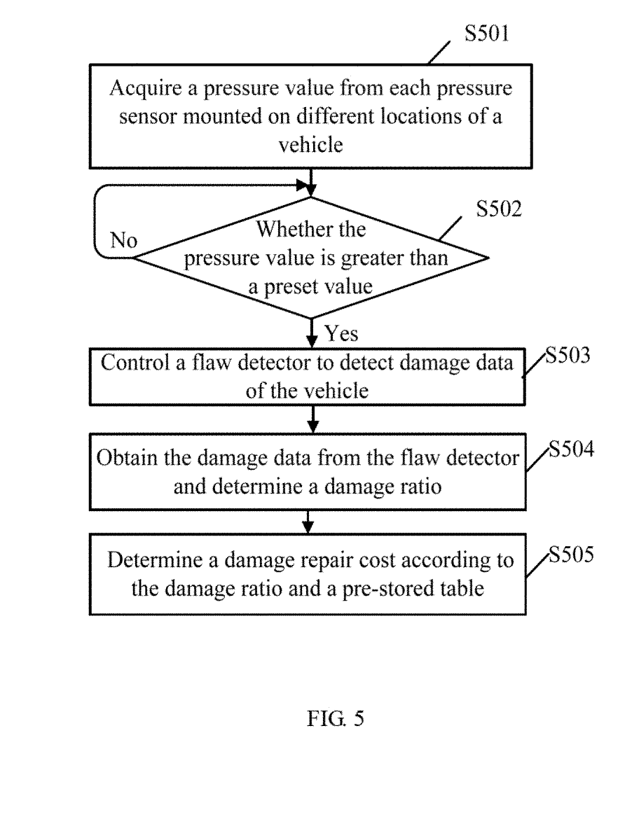

FIG. 5 illustrates a repair cost calculating method for calculating repair cost of a damage. The method is applied in a cost calculating device. The method is provided by way of example, as there are a variety of ways to carry out the method. The method described below can be carried out using the configurations illustrated in FIG. 1, for example, and various elements of these figures are referenced in explaining the example method. Each block shown in FIG. 5 represents one or more processes, methods, or subroutines carried out in the example method. Additionally, the illustrated order of blocks is by example only and the order of the blocks can be changed. The example method can begin at block 501.

At block 501, a processor acquires a pressure value from each pressure sensor mounted on different locations of a vehicle.

At block 502, the processor determines whether the acquired pressure value is greater than a preset value. If the acquired pressure value is greater than the preset value, the procedure goes to block 503, otherwise, the block 502 is repeated.

At block 503, the processor controls a flaw detector to detect damage data of the vehicle. In the exemplary embodiment, the damage data can include a location of the damage, a type of the damage, and a size of the damage area.

At block 504, the processor obtains the damage data from the flaw detector and determines a damage ratio according to the damage data obtained from the flaw detector and a pre-stored data which represents an undamaged vehicle.

In the exemplary embodiment, the determination as to damage ratio by the analysis module 13 can include: comparing the damage data with the pre-stored data; determining a name of the damaged component according to the location of the damage if the damage data is different from the pre-stored data; and determining a damage ratio according to a difference between the damage data and the pre-stored data. In the exemplary embodiment, the damage ratio may be equal to zero or greater than zero, and will be less than or equal to one.

At block 505, the processor determines a damage repair cost according to the damage ratio determined by the analysis module and a pre-stored table. In one embodiment, the pre-stored table records a name of each component of the vehicle, and a relationship between damage ratios and damage repair costs of each component of the vehicle. The processor obtains the damage repair cost from the table according to the damage ratio. In an alternative embodiment, the table records an original price of each component of the vehicle, the processor obtains the original price of the damaged component of the vehicle, and calculates the damage repair cost by multiplying the original price of the damage component by the damage ratio to get the damage repair cost.

In the exemplary embodiment, the processor further outputs the damage repair cost to the user by displaying a user interface on a display device.

In the exemplary embodiment, the damage repair cost calculating method further can include: summing the damage repair cost of each damaged component to get a total damage repair cost if there are more than one component is damaged.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A repair cost calculating device comprising:
a plurality of pressure sensors to detect a pressure value when a collision is occurred to a vehicle;
at least one flaw detector to detect damage data of the vehicle, wherein the damage data comprises a location of the damage, a type of the damage, a size of the damage area, and a depth of the damage area;
at least one processor coupled to the pressure sensors and the at least one flaw detector; and
at least one storage device storing one or more programs, when executed by the at least one processor, the one or more programs cause the at least one processor to:
acquire a pressure value from each of the pressure sensors and determine whether the pressure value is greater than a preset value;
control the at least one flaw detector to detect the damage data of the vehicle if the acquired pressure value is greater than the preset value;
obtain the damage data from the at least one flaw detector and determine a damage ratio according to the damage data and a pre-stored data which represents an undamaged vehicle; and
determine a damage repair cost according to the damage ratio and a pre-stored table recording a relationship between different damage ratios and damage repair cost.

2. The repair cost calculating device of claim 1, wherein the one or more programs further cause the at least one processor to: compare the damage data with the pre-stored data; determine a name of the damaged component according to a location of the damage if the damage data is different from the pre-stored data; and determine a damage ratio according to a difference between the damage data and the pre-stored data.

3. The repair cost calculating device of claim 2, wherein the pre-stored table records a name of each component of the vehicle and a relationship between damage ratios and damage repair costs of each component of the vehicle; the processor obtains damage repair cost of each damaged component of the vehicle from the pre-stored table according to the damage ratio, and sums all the damage repair costs of the damaged component to get a total damage repair cost.

4. The repair cost calculating device of claim 2, wherein the pre-store table records an original price of each component of the vehicle, the processor obtains the original price of the damaged component, calculates the damage repair cost by multiplying the original price of the damaged component by the damage ratio to get the damage repair cost.

5. The repair cost calculating device of claim 1, further comprising a display device, wherein the processor controls the display device to display the damage repair cost.

6. The repair cost calculating device of claim 5, wherein the processor further obtains an image of a damaged component and controls the display device to display the image of the damaged component.

7. A repair cost calculating method applied in a repair cost calculating device, the repair cost calculating device comprising at least one processor, a plurality of pressure sensors to detect a pressure value when a collision is occurred to the vehicle, and at least one flaw detector to detect damage data of the vehicle, the method comprising:
acquiring a pressure value from each of the pressure sensors and determining whether the pressure value is greater than a preset value;
controlling the at least one flaw detector to detect damage data of the vehicle if the acquired pressure value is greater than the preset value, wherein the damage data comprises a location of the damage, a type of the damage, a size of the damage area, and a depth of the damage area;
obtaining the damage data from the at least one flaw detector and determining a damage ratio according to the damage data and a pre-stored data which represents an undamaged vehicle; and
determining a damage repair cost according to the damage ratio and a pre-stored table recording a relationship between different damage ratios and damage repair costs.

8. The repair cost calculating method of claim 7, further comprising: comparing the damage data with the pre-stored data; determining a name of the damaged component according to a location of the damage if the damage data is different from the pre-stored data; and determining a damage ratio according to a difference between the damage data and the pre-stored data.

9. The repair cost calculating method of claim 8, wherein the pre-stored table records a name of each component of the vehicle and a relationship between damage ratios and damage repair costs of each component of the vehicle; the processor obtains damage repair cost of each damaged component of the vehicle from the pre-stored table according to the damage ratio, and sums all the damage repair costs of the damaged component to get a total damage repair cost.

10. The repair cost calculating method of claim 8, wherein the pre-store table records an original price of each component of the vehicle, the processor obtains the original price of the damaged component, calculates the damage repair cost by multiplying the original price of the damaged component by the damage ratio to get the damage repair cost.

11. The repair cost calculating method of claim 7, further comprising outputting the damage repair cost by using a display device.

12. The repair cost calculating method of claim 11, further comprising:
obtaining an image of a damaged component; and
displaying the image of the damage component on the display device.
